(19) United States
(12) Patent Application Publication
(10) Pub. No.: US 2025/0390046 A1
(43) Pub. Date: Dec. 25, 2025

(54) IMAGE FORMING SYSTEM AND COMPUTER-READABLE RECORDING MEDIUM STORING CONTROL PROGRAM

(71) Applicant: Konica Minolta, Inc., Tokyo (JP)

(72) Inventors: Satoshi Ogata, Tokyo (JP); Junichi Masuda, Toyokawa-shi (JP); Hiroyuki Yoshikawa, Toyohashi-shi (JP); Akimasa Ishikawa, Tokyo (JP)

(73) Assignee: Konica Minolta, Inc., Tokyo (JP)

(21) Appl. No.: 19/221,990

(22) Filed: May 29, 2025

(30) Foreign Application Priority Data
Jun. 19, 2024 (JP) 2024-098579

(51) Int. Cl. G03G 15/00

(52) U.S. Cl. CPC G03G 15/5029; G03G 15/5012; G03G 15/6508; G03G 2215/00776

(57) ABSTRACT

An image forming system includes: a first detector that is disposed in a conveyance path at a position upstream of an image former in a conveyance direction of a sheet and that detects a characteristic value corresponding to an amount of moisture of the conveyed sheet; and a controller that determines whether or not the characteristic value detected by the first detector is stable and causes the image former to start image formation when determining that the characteristic value is stable.

### CROSS-REFERENCE TO RELATED APPLICATION

The entire disclosure of Japanese patent application No. 2024-098579, filed on Jun. 19, 2024, is incorporated herein by reference in its entirety.

### BACKGROUND OF THE INVENTION

### 1. Technical Field

The present invention relates to an image forming system and a computer-readable recording medium storing a control program.

### 2. Description of Related art

In order to generate a printed product having a stable quality, test printing is performed in some cases before main printing in order to confirm whether or not the state of the sheet is appropriate and whether or not there is a problem with print settings and image forming conditions of an image forming apparatus for the sheet.

For example, a printing system disclosed in Japanese Unexamined Patent Application Publication No. 2009-12294 attaches a waste sheet mark on the side of a roll-shaped continuous sheet in order to identify the position of main printing and performs test printing when receiving a test printing instruction at the time of printing on the continuous sheet. When receiving an instruction to switch from the test printing to the main printing from an operator via a panel, the printing system ends the test printing with the waste sheet mark and starts the main printing.

### SUMMARY OF THE INVENTION

However, in the printing system disclosed in Japanese Unexamined Patent Application Publication No. 2009-12294, the switching from the test printing to the main printing is performed by the operator giving an instruction via the panel after confirming the print quality such as image quality. For this reason, this system is under the supervision of the operator, and thus, the skill and work load required for the operator are high. Furthermore, the print quality is likely to vary depending on the skill of the operator. In addition, consumable supplies such as sheet, ink, and toner are consumed by the test printing.

The present invention has been made in view of the above-described circumstance, and an object of the present invention is to reduce the burden on an operator and to reduce the consumption of consumable supplies.

To achieve at least one of the abovementioned objects, according to an aspect of the present invention, a system reflecting one aspect of the present inventions comprises the followings.

(1) An image forming system including:
an image former that forms an image on a sheet conveyed through a conveyance path;
a first detector that is disposed on the conveyance path at a position upstream of the image former in a conveyance direction of the sheet and that detects a characteristic value corresponding to an amount of moisture of the conveyed sheet; and
a controller that performs a determination of whether or not the characteristic value detected by the first detector is stable and causes the image former to start image formation when determining that the characteristic value is stable.

### BRIEF DESCRIPTION OF THE DRAWINGS

The advantages and features provided by one or more embodiments of the present invention will be more fully understood from the following detailed description and the accompanying drawings. However, these are for purposes of illustration only and are not intended to limit the present invention.

FIG. 1 is a diagram illustrating a schematic configuration of an image forming system according to the present embodiment;

FIG. 2 is a block diagram of the image forming system;

FIG. 3 is a block diagram of a sheet characteristic detection device;

FIG. 4 is a diagram illustrating a schematic configuration of the sheet characteristic detection device;

FIG. 5 is a diagram illustrating a schematic configuration of a moisture percentage sensor;

FIG. 6 is a diagram illustrating a schematic configuration of a basis weight sensor;

FIG. 7A is a block diagram illustrating a process of determining a control parameter from sheet characteristics in a first example;

FIG. 7B is a block diagram illustrating a process of determining a control parameter from sheet characteristics in a second example;

FIG. 8 is a flowchart illustrating printing processing according to a first embodiment;

FIG. 9 is a subroutine flowchart illustrating change amount calculation processing of step S05 in FIG. 8;

FIG. 10 is a graph illustrating transition of an amount of moisture of sheets continuously conveyed from a sheet feed tray;

FIG. 11A is a flowchart illustrating printing processing in a second embodiment; and

FIG. 11B is a flowchart illustrating printing processing to be executed subsequent to FIG. 11A.

### DETAILED DESCRIPTION

Embodiments of the present invention will be described below with reference to the accompanying drawings. It is to be noted that the scope of the present invention is not limited to the embodiments to be described. Note that in the description of the drawings, the same components are denoted by the same reference signs, and redundant descriptions will not be repeated. In addition, dimensional ratios in the drawings are exaggerated for convenience of description and may be different from actual ratios. In the drawings, a top-bottom direction (vertical direction) is defined as a Z direction, a front direction and a rear direction of an image forming system or a sheet characteristic detection device are defined as a Y direction, and a direction orthogonal to the Y and Z directions is defined as an X direction. The X direction is also referred to as a conveyance direction of a sheet. The Y direction is also referred to as a width direction. In the present embodiment, the sheet includes a printing sheet (hereinafter simply referred to as sheet) and various films. In particular, the sheet includes a sheet produced by using mechanical pulp and/or chemical pulp derived from a plant. Examples of the types of sheets include coated glossy paper, matt paper, uncoated plain paper, and high-quality paper.

Cut sheet is used as the sheet, but continuous sheet (roll sheet) may be used. In a case where the cut sheet is used, measurement is performed once for each sheet by the sheet characteristic detection device. In addition, in a case where the continuous sheet is used, the measurement is performed by the sheet characteristic detection device at a cycle corresponding to one cut sheet (for example, corresponding to A3). Furthermore, although an electrophotographic method using toner will be described below as an example of a method of the image forming apparatus, another method such as an inkjet method may be applied.

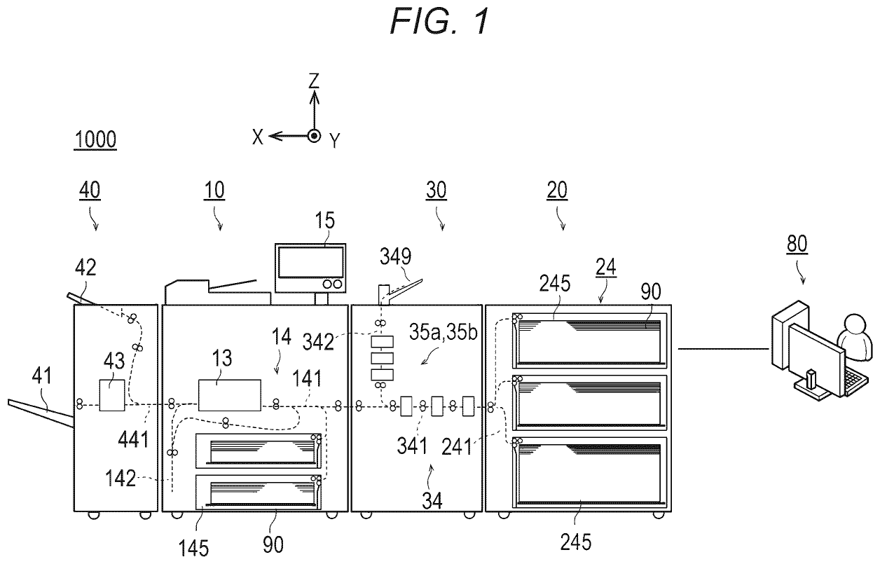

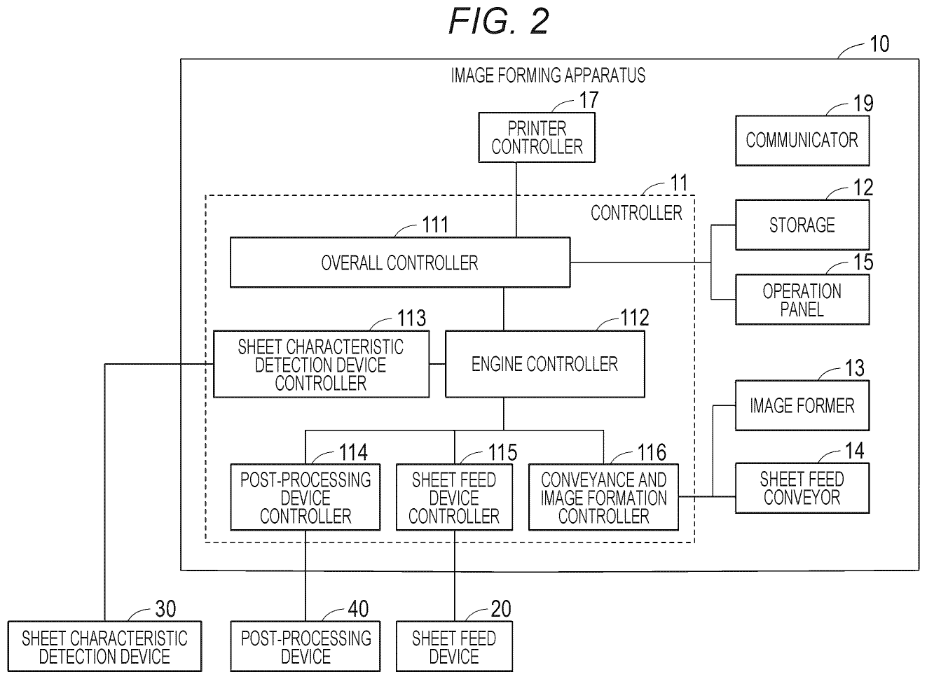

FIG. 1 is a diagram illustrating a schematic configuration of an image forming system 1000 according to the present embodiment. FIG. 2 is a block diagram illustrating a hardware configuration of the image forming system 1000. As illustrated in FIG. 1, the image forming system 1000 includes an image forming apparatus 10, a sheet feed device 20, a sheet characteristic detection device 30, and a post-processing device 40, which are mechanically and electrically connected to each other. Further, the image forming system 1000 is connected to a terminal device 80 such as a PC.

### Image Forming Apparatus 10

The image forming apparatus 10 forms an image on a sheet 90 sent from the sheet characteristic detection device 30 located on an upstream side. The image forming apparatus 10 includes a controller 11, a storage 12, an image former 13, a sheet feed conveyor 14, an operation panel 15, a printer controller 17, a communicator 19, and the like. These components are connected to each other via a signal line such as a bus for exchanging signals.

### Controller 11

The controller 11 includes a CPU, a ROM, a RAM, and the like. The controller 11 executes various kinds of processing by executing programs stored in the ROM and the storage 12 described later, and controls various parts of the apparatus and executes various kinds of calculation processing in accordance with the programs. The controller 11 functions as an overall controller 111, an engine controller 112, a sheet characteristic detection device controller 113, a post-processing device controller 114, a sheet feed device controller 115, and a conveyance and image formation controller 116. The functions of these sub-controllers 111 to 116 will be described later.

### Storage 12

The storage 12 includes a ROM that stores various programs and various types of data in advance, a RAM that temporarily stores programs and data as a work area, and an auxiliary storage such as a hard disk that stores various programs and various types of data. In addition, the storage 12 stores sheet information regarding sheets stored in each sheet feed tray. The sheet information includes information regarding the brand, size (sheet width, sheet length), basis weight (weight), and type (gloss coated paper, matt coated paper, plain paper, high-quality paper, rough paper, etc.) of the sheet. In addition, the storage 12 may store a sheet brand, a determination model (determination model algorithm) used for determining a control parameter, and a paper profile.

### Image Former 13

The image former 13 forms an image by, for example, an electrophotographic method. The image former 13 includes writing sections and photosensitive drums respectively corresponding to basic colors of yellow (Y), magenta (M), cyan (C), and black (K), and developing devices each accommodating a two-component developer including toner of the corresponding color and a carrier. The image former 13 further includes an intermediate transfer belt, a secondary transferer, and a fixer. Toner images formed on the photosensitive drums by the developing devices of the respective colors are superimposed on the intermediate transfer belt, and are transferred onto the conveyed sheet 90 at the secondary transferer. The toner image on the sheet 90 is fixed on the sheet 90 by being heated and pressed by the fixer on a downstream side.

### Sheet Feed Conveyor 14

The sheet feed conveyor 14 includes conveyance paths 141 and 142, a plurality of sheet feed trays 145, and the like. The conveyance path 141 includes a plurality of conveyance roller pairs provided along the conveyance path and a drive motor (not illustrated) that drives the conveyance roller pairs. The sheet feed conveyor 14 includes a delivery roller that delivers an uppermost sheet of a plurality of sheets 90 loaded and placed in the sheet feed tray 145, and delivers (feeds) the sheets 90 in the sheet feed tray to a conveyance path on the downstream side one by one. A first conveyance path 341 of the sheet characteristic detection device 30 is connected to the upstream side of the conveyance path 141.

The sheet feed conveyor 14 conveys the sheet 90 fed from the sheet feed tray 145 and the like. The sheet 90 conveyed through the conveyance path 141 is subjected to image formation by the image former 13, and then ejected onto a sheet ejection tray 41 via the subsequent post-processing device 40. In double-sided printing in which an image is also formed on the back surface of the sheet 90, the sheet 90 on which an image has been formed on one side is conveyed to the conveyance path 142 for double-sided image formation in a lower portion of the apparatus body. The sheet 90 conveyed to the conveyance path 142 is turned over on a switchback path and then conveyed to the conveyance path 141 for single-sided printing, and an image is again formed on the other side of the sheet 90 by the image former 13.

### Operation Panel 15, etc.

The operation panel 15 that includes a touch screen, a numeric keypad, a start button, a stop button, etc. displays a state of the image forming apparatus 10 or the image forming system 1000 and is used for input, from a user, of instructions and settings such as the type of the sheet placed on the sheet feed tray 145 or the like. In addition, the operation panel 15 displays a warning to the user in a case where stabilization of a sheet state which will be described later cannot be achieved within a predetermined number of sheets.

The printer controller 17 acquires a print job transmitted from a terminal device such as a personal computer (PC). Print data (image data) described in a page description language (PDL) format or a portable document format (PDF) included in the print job is rasterized by the printer controller 17 to be converted into image data for each page in a raster format, and is temporarily stored in a page memory. The image data from the page memory is read at a predetermined timing, stored in a buffer, and output as an exposure signal to the writing section for each main scanning line in synchronization with a writing timing.

The communicator 19 is an interface for communicating with other devices.

### Sub-Controllers 111 to 116

When receiving a print job, the overall controller 111 causes the engine controller 112 to execute the print job on the basis of print job setting information about the input print job.

The print job is input in response to an instruction sent from the operation panel 15 or an external terminal such as the network-connected terminal device 80 operated by the user.

The engine controller 112 performs later-described printing processing illustrated in FIG. 5, etc. by controlling the post-processing device controller 114, the sheet feed device controller 115, and the conveyance and image formation controller 116. The post-processing device controller 114 controls the post-processing device 40. Specifically, the post-processing device controller 114 transmits, to the post-processing device 40, a sheet conveyance timing, information regarding setting of post-processing for a sheet to be conveyed, and the like. The sheet feed device controller 115 controls the sheet feed device 20. Specifically, the sheet feed device controller 115 communicates with the sheet feed device 20 to transmit and receive the sheet feed tray to be used, the sheet conveyance timing, and the like.

The conveyance and image formation controller 116 controls the feed and conveyance of the sheet 90 by controlling the sheet feed conveyor 14 (including drive motors for the conveyance paths 141 and 142, the fixer, and the like). The conveyance and image formation controller 116 also controls the image former 13 to control an image formation condition and an image formation timing according to a sheet position.

In response to an execution instruction request from the engine controller 112, the sheet characteristic detection device controller 113 controls the sheet characteristic detection device 30 to execute measurement of the sheet characteristic by various sensors included in the sheet characteristic detection device 30.

### Sheet Feed Device 20

As illustrated in FIG. 1, the sheet feed device 20 includes a sheet feed conveyor 24. The sheet feed conveyor 24 has a function equivalent to that of the above-described sheet feed conveyor 14. In addition, the sheet feed device 20 includes a controller, a storage, and a communicator (none of which are illustrated) in addition to the sheet feed conveyor 24, and these components are connected to each other via a signal line such as a bus for exchanging signals. The sheet feed conveyor 24 includes a plurality of sheet feed trays 245 and a conveyance path 241. The conveyance path 241 is connected to the conveyance path 341. The sheet 90 fed from each sheet feed tray 245 and conveyed through the conveyance path 241 is conveyed to the sheet characteristic detection device 30 on the downstream side, and the sheet characteristic is measured or an image is formed by the image forming apparatus 10 on the further downstream side. The sheet feed conveyor 24 of the sheet feed device 20 feeds the uppermost sheet of a bundle of sheets accommodated in the sheet feed tray 245 one by one.

### Post-Processing Device 40

The post-processing device 40 performs post-processing on the sheet 90 sent from the image forming apparatus 10 or ejects the sheet 90 according to the setting of the print job. The post-processing device 40 includes sheet ejection trays 41 and 42, a post-processor 43, and a conveyance path 441. In addition, the post-processing device 40 includes a controller, a storage, a conveyor, and a communicator (none of which are illustrated), and these components are connected to each other via a signal line such as a bus for exchanging signals. The sheet ejection trays 41 and 42 are selected according to the setting of the print job. The conveyance path 441 is connected to the conveyance path 141 on the upstream side. The post-processor 43 performs at least one of stapling, punching, cutting, folding, or bookbinding on the sheet 90 on which an image has been formed.

### Sheet Characteristic Detection Device 30

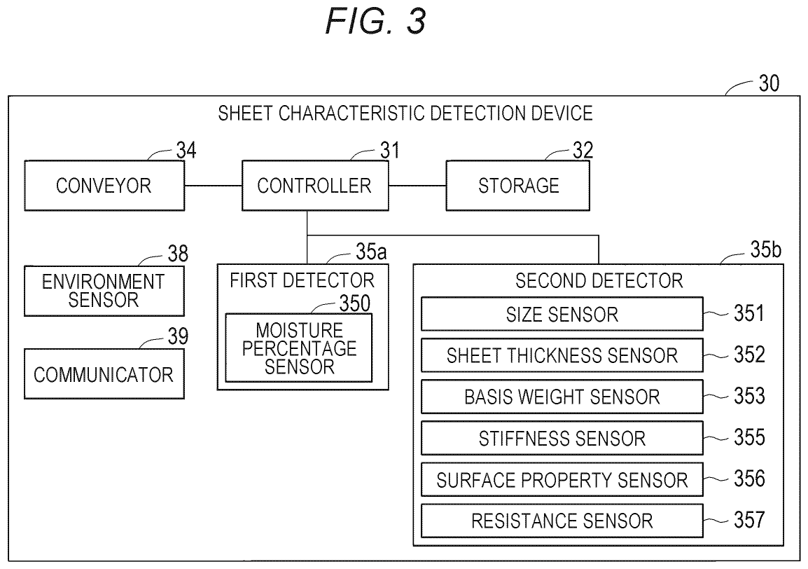

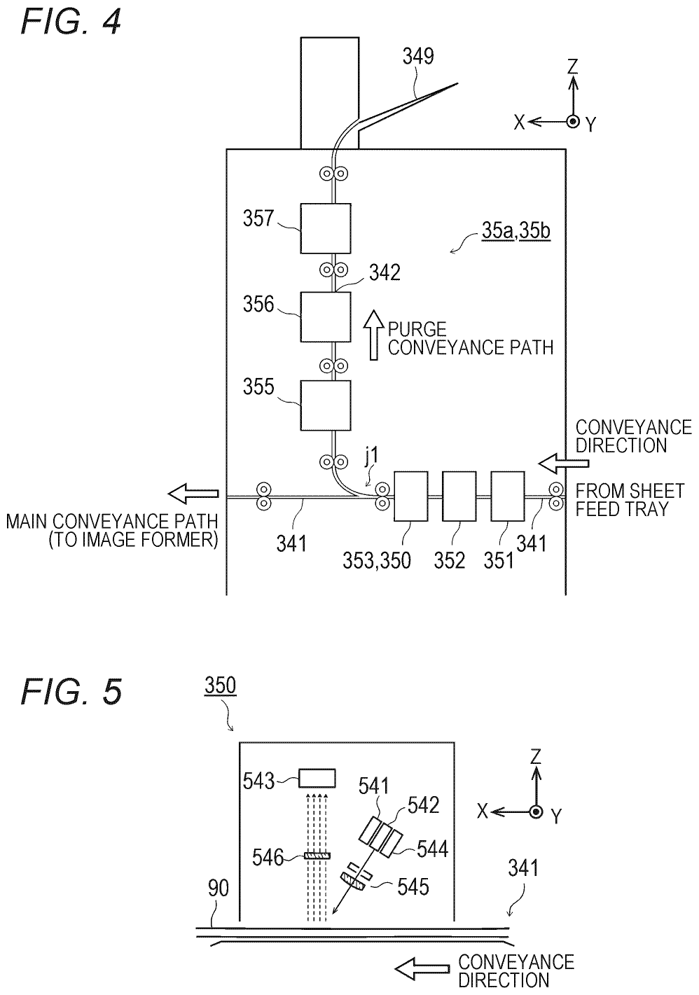

Next, the sheet characteristic detection device 30 will be described with reference to FIGS. 3 to 6. FIG. 3 is a block diagram of the sheet characteristic detection device 30, and FIG. 4 is a diagram illustrating a schematic configuration of the sheet characteristic detection device 30. The sheet characteristic detection device 30 includes a controller 31, a storage 32, a conveyor 34, a first detector 35a, a second detector 35b, an environment sensor 38, and a communicator 39. The environment sensor 38 detects at least one of temperature and humidity in the device body. The communicator 39 is an interface for communicating with other devices.

Similarly to the controller 11 described above, the controller 31 includes a CPU and a memory. The controller 31 causes the first detector 35a and the second detector 35b to detect sheet characteristic information corresponding to the sheet characteristics of the sheet 90 by controlling the operation of the first detector 35a and the second detector 35b.

The storage 32 includes a ROM that stores various programs and various types of data in advance, a RAM that temporarily stores programs and data as a work area, and an auxiliary storage such as a hard disk that stores various programs and various types of data. The storage 32 also stores an environment correction table in which detection values of the environment sensor 38 are associated with correction values. The controller 31 may correct a detection result of a sensor of each of the first detector 35a and the second detector 35b in accordance with the detection value of the environment sensor 38 and the environment correction table.

The conveyor 34 includes a first conveyance path 341, a second conveyance path 342, and a purge tray 349 for ejecting the sheet 90 to be purged. The first and second conveyance paths 341 and 342 include a plurality of conveyance roller pairs provided along the conveyance paths and drive motors (not illustrated) that drive the conveyance roller pairs. The first conveyance path 341 is a main conveyance path, and has an upstream side connected to the conveyance path 241 of the sheet feed device 20 and a downstream side connected to the conveyance path 141 of the image forming apparatus 10. The second conveyance path 342 is branched from the first conveyance path 341 at a branch portion j1. In the second conveyance path 342, the sheet 90 to be purged to the purge tray 349 is conveyed without passing through the image former 13 (disposed on the conveyance path 141). The first conveyance path 341 extends in a substantially horizontal direction. At least a part of the second conveyance path 342 extends in a substantially vertical direction. In particular, in an area where a stiffness sensor 355 to be described later is disposed, the second conveyance path 342 extends in the substantially vertical direction, and the sheet is conveyed in the upward direction. Here, being substantially vertical indicates being within a range of 90±1°. Note that the second conveyance path 342 is not required to be entirely linear. As long as at least a measurement area of the stiffness sensor 355 in the second conveyance path 342 is straight, the other paths may be partially curved. For example, the second conveyance path 342 may be an S-shaped curved conveyance path as a whole.

### Relationship of Placement Positions of Sensors

FIGS. 3 and 4 are referred to. As illustrated in FIGS. 3 and 4, the first detector 35a includes a moisture percentage sensor 350 that detects an amount of moisture as a sheet characteristic. The second detector 35b includes a plurality of sensors that respectively detect a plurality of types of sheet characteristics. The plurality of sensors of the second detector 35b includes a size sensor 351, a sheet thickness sensor 352, a basis weight sensor 353, a stiffness sensor 355, a surface property sensor 356, and a resistance sensor 357. These sensors of the first and second detectors 35a and 35b may use, as the sheet characteristic information, characteristic values or physical property values themselves of the sheet or values indicating the characteristics such as current and voltage of the sensors corresponding to the characteristic values or the physical property values.

As illustrated in FIG. 4, the basis weight sensor 353 and the moisture percentage sensor 350 are disposed downstream of the sheet thickness sensor 352 on the first conveyance path 341. The basis weight sensor 353 and the moisture percentage sensor 350 are arranged at the same position in the conveyance direction (X direction) and at different positions in the width direction (Y direction) on the first conveyance path 341. The size sensor 351 is disposed upstream of the moisture percentage sensor 350 on the first conveyance path 341.

The sheet thickness sensor 352 is the second sensor from the upstream side. Since the sheet characteristic detection device 30 detects the thickness of the sheet 90 first, it is possible to appropriately set, for example, a measurement range (latitude), a measurement condition, and the like at the time of detection by the basis weight sensor 353 and the moisture percentage sensor 350 at the subsequent stage.

The moisture percentage sensor 350 of the first detector 35a and the size sensor 351, the sheet thickness sensor 352, and the basis weight sensor 353 of the second detector 35b, which are arranged on the first conveyance path 341, do not affect the productivity. That is, these sensors 350 to 353 disposed on the first conveyance path 341 detect sheet characteristic information corresponding to the size, the sheet thickness, the basis weight, and the amount of moisture (moisture percentage) while conveying the sheet 90 conveyed through the first conveyance path 341 without stopping the sheet 90. Thus, when a print job of continuously performing printing is executed, the sheet characteristic detection device 30 can detect the sheet characteristic information of each of a plurality of sheets 90 continuously conveyed. That is, these sensors can detect the sheet characteristic information of all the sheets. In the sheet characteristic information, the sheet characteristic information regarding the size, the sheet thickness, and the basis weight is sheet characteristic information corresponding to a paper type (sheet type), and the sheet characteristic information regarding the moisture percentage is sheet characteristic information corresponding to a change of state of the sheet 90. Note that the stiffness sensor 355, the surface property sensor 356, and the resistance sensor 357 disposed on the second conveyance path 342 detect the respective sheet characteristics after the sheet 90 is temporarily stopped.

As described above, the moisture percentage sensor 350 of the first detector 35a detects the sheet characteristic information corresponding to a change in the state of the sheet 90 every time. This can provide an appropriate detection of a case where the state of the sheets 90 loaded in the sheet feed tray is not stable and changes during continuous printing or a case where a bundle of sheets includes sheets whose state is not uniform (hereinafter, referred to as inappropriate sheet). Then, when detecting an inappropriate sheet 90, the sheet characteristic detection device 30 conveys the sheet 90 to the purge conveyance path (second conveyance path 342) and ejects the sheet onto the purge tray 349 as described later. In this way, it is possible to prevent a change in the image quality due to the unstable sheet state, and to prevent a conveyance failure such as a jam from occurring in the image forming apparatus 10, the post-processing device 40, or the like due to the use of the sheet 90 having a large amount of moisture. The situation in which the state of sheets in the bundle of sheets loaded in the sheet feed tray is not uniform occurs due to, for example, the following two cases. The first case is that, when the bundle of sheets is left in a high-humidity room, the sheet on the upper end side (or the sheet on the lower end side) of the bundle of sheets absorbs moisture more quickly, and thus the amount of moisture is different between sheets in the middle of the bundle and sheets on the upper end of the bundle. The second case is that, when sheets included in a bundle of sheets in the sheet feed tray are replenished without being used up, a bundle of sheets having different amount of moisture is stacked.

### Moisture Percentage Sensor 350

FIG. 5 is a diagram illustrating the schematic configuration of the moisture percentage sensor 350. The moisture percentage sensor 350 measures the moisture percentage or the amount of moisture of the sheet 90.

As illustrated in FIG. 5, the moisture percentage sensor 350 includes a first light emitter 541, a second light emitter 542, a light receiver 543, a temperature detection sensor 544, lenses 545 and 546, and the like. The first light emitter 541 and the second light emitter 542 are light emitters that emit light toward a sheet.

The first light emitter 541 emits first near-infrared light (reference light) in a specific wavelength band toward a sheet P. Specific examples of the first light emitter 541 include a light emitting diode (LED). The first near-infrared light is light whose absorptance by the sheet P upon reflection on the sheet P is not affected by the moisture percentage of the sheet P. The light receiver 543 receives, via the lens 546, the first near-infrared light emitted from the first light emitter 541 and reflected on the sheet P via the lens 545. Then, the light receiver 543 outputs, to the controller 31, information about a first light reception amount which is a received amount of the reflected first near-infrared light. Specific examples of the light receiver 543 include a charge-coupled device (CCD) and a complementary metal-oxide-semiconductor (CMOS) image sensor.

The second light emitter 542 emits second near-infrared light in a specific wavelength band toward the sheet P. Specific examples of the second light emitter 542 include an LED. The second near-infrared light is light whose absorptance by the sheet P upon reflection on the sheet P varies with the moisture percentage of the sheet P. The light receiver 543 receives, via the lens 546, the second near-infrared light emitted from the second light emitter 542 and reflected on the sheet P via the lens 545. Then, the light receiver 543 outputs, to the controller 31, information about a second light reception amount which is a received amount of the reflected second near-infrared light.

That is, the first light emitter 541 and the second light emitter 542 emit light beams having wavelengths with different absorptance by moisture of the sheet. The second near-infrared light emitted from the second light emitter 542 is light having a wavelength that is absorbed more by the moisture of the sheet than the first near-infrared light (reference light) emitted from the first light emitter 541.

The controller 31 determines the moisture percentage of the sheet based on a ratio of the first light reception amount and the second light reception amount (a ratio of the output of the light receiver 543 to the first near-infrared light and the second near-infrared light). As the moisture percentage of the sheet is higher, an absorption amount of the second near-infrared light is larger, and thus the second light reception amount is smaller. Therefore, based on a relational expression or a table indicating a relationship between the moisture percentage of the sheet and the ratio of the first light reception amount and the second light reception amount, the controller 31 can associate the ratio of the first light reception amount and the second light reception amount with the moisture percentage of the sheet, and calculate the moisture percentage of the sheet from the ratio of the first light reception amount and the second light reception amount.

### Size Sensor 351

The size sensor 351 optically detects the size (shape) of the sheet 90. The size sensor 351 is, for example, a line sensor whose detection area is the entire area in the sheet width direction. The controller 31 performs image processing on the obtained read image data for one sheet 90 to detect edges (positions of four sides or an outer shape) of the sheet 90 and detect the size (shape) of the sheet 90.

### Sheet Thickness Sensor 352

The sheet thickness sensor 352 detects the thickness of the sheet 90 by mechanically measuring a displacement amount. The sheet thickness sensor 352 includes a conveyance roller pair and a displacement sensor. One of the pair of conveyance rollers is a driven roller, and the shaft height of the driven roller is measured by the displacement sensor, by which the thickness of the sheet 90 conveyed to the nip is detected. The displacement sensor includes an actuator (detection lever) that is in contact with the shaft of the driven roller which is the upper roller and an encoder that measures the rotation amount of the actuator. For example, the sheet thickness (micron) is output from the sheet thickness sensor 352 as a measurement result of the sheet thickness.

### Basis Weight Sensor 353

The basis weight sensor 353 that is a transmission-type or reflection-type optical sensor for detecting the basis weight of the sheet includes a light emitter and a light receiver, and detects the basis weight of the sheet 90 by measuring an attenuation amount (transmittance) of light transmitted through the sheet 90 and an amount of reflected light.

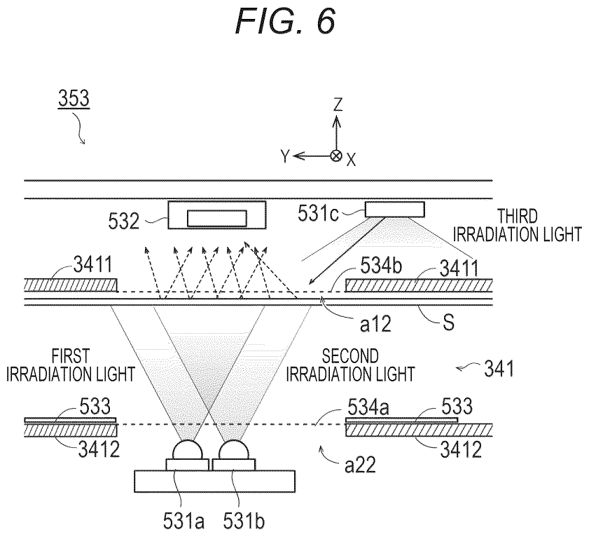

FIG. 6 is a diagram illustrating a schematic configuration of the basis weight sensor 353. As illustrated in FIG. 6, the basis weight sensor 353 includes a plurality of light emitters 531 and a single light receiver 532. The light emitters 531 include a first light emitter 531a, a second light emitter 531b, and a third light emitter 531c. First irradiation light, second irradiation light, and third irradiation light are emitted from the first, second, and third light emitters, respectively, to an irradiation area. The irradiation area (second irradiation area) is an inner area in an opening a12 when viewed in the Z direction. The opening a12 is provided in an upper guide plate 3411. A lower guide plate 3412 is also provided with an opening a22 at a position facing the opening a12. The openings a12 and a22 have the same shape, for example, a rectangular shape. In order to prevent a foreign substance such as paper dust from the sheet 90 passing through the first conveyance path 341 from adhering to the openings a12 and a22, transparent sheets 534a and 534b made of PET or the like that allow the first irradiation light, the second irradiation light, and the third irradiation light having different wavelengths to pass therethrough are attached at the openings a12 and a22.

The first light emitter 531a emits the first irradiation light having a first wavelength. The first wavelength is, for example, the wavelength of a near-infrared ray longer than the wavelength of a visible light ray. More specifically, the first wavelength includes, for example, a wavelength between 750 nm and 900 nm. The second light emitter 531b emits the second irradiation light having a second wavelength. The second wavelength is, for example, the wavelength of a blue light ray included in the visible light ray. More specifically, the second wavelength includes, for example, a wavelength between 400 nm and 470 nm. The first light emitter 531a and the second light emitter 531b are both disposed on the opposite side from the light receiver 532 with respect to the first conveyance path 341, and the third light emitter 531c is provided on the same side as the light receiver 532 and in the vicinity of the light receiver 532. The third light emitter 53 1c emits the third irradiation light having a third wavelength toward the irradiation area (the opening a12). The third wavelength is, for example, the wavelength of a green light ray included in the visible light ray. More specifically, the third wavelength includes, for example, a wavelength between 495 nm and 570 nm. The third wavelength is different from the first wavelength (for example, a wavelength between 750 nm and 900 nm) and the second wavelength (for example, a wavelength between 400 nm and 470 nm). The third irradiation light is emitted toward the first conveyance path 341 between the upper and lower guide plates 3411 and 3412. A reflector 533 is provided on an inner side of the lower guide plate 3412 provided near the first light emitter 531a and the second light emitter 531b. The reflector 533 is coated with, for example, green which is the same color as the third irradiation light, and reflects the third irradiation light. The reflector 533 does not reflect the first irradiation light (near-infrared ray) and the second irradiation light (blue light ray), which do not have the same color as the third irradiation light.

In the present embodiment, during the measurement, the controller 31 causes the first light emitter 531a and the second light emitter 531b to emit the first irradiation light and the second irradiation light at different timings by controlling the first light emitter 531a and the second light emitter 531b. The light receiver 532 receives the first irradiation light and the second irradiation light, detects the amounts of the first irradiation light and the second irradiation light, and outputs the detected amounts of the first irradiation light and the second irradiation light to the controller 31. Similarly, the controller 31 irradiates the sheet 90 conveyed to the position of the opening a12 with the first irradiation light and the second irradiation light. The light receiver 532 receives the transmitted first irradiation light and the transmitted second irradiation light (first transmitted light and second transmitted light), detects the amounts of the first transmitted light and the second transmitted light, and outputs, to the controller 31, the detected amount of the first transmitted light and the detected amount of the second transmitted light. That is, the light receiver 532 detects the first irradiation light and the second irradiation light when the sheet 90 is absent, and detects the first transmitted light and the second transmitted light when the sheet 90 is present at the opening a12.

Regarding the third light emitter 531c, similarly, the light receiver 532 detects first reflection light reflected by the reflector 533 when the sheet 90 is absent, and detects second reflection light reflected by the front surface of the sheet 90 when the sheet 90 is present at the opening a12.

The controller 31 calculates a first transmittance by dividing the amount of the first transmitted light by the amount of the first irradiation light. Similarly, the controller 31 calculates a second transmittance by dividing the amount of the second transmitted light by the amount of the second irradiation light. Then, the controller 11 determines the type of the sheet 90 based on the first and second transmittances and a determination criterion stored in the storage 12.

The controller 31 may calculate a reflectance by dividing the amount of the second reflection light by the amount of the first reflection light in addition to the first transmittance and the second transmittance, and may determine the type of the sheet 90 in consideration of the reflectance. The third light emitter 531c and the reflector 533, which are provided in the present embodiment, may be omitted.

### Stiffness Sensor 355

The stiffness sensor 355 detects the stiffness of the sheet 90 by mechanically measuring a displacement amount. The stiffness sensor 355 is disposed vertically below the pair of rollers holding the stopped sheet 90 on the second conveyance path 342 that extends in the vertical direction.

The stiffness sensor 355 detects the bending rigidity with the leading end (or trailing end) of the sheet 90 as a free end. The stiffness sensor 355 includes a holding member, a push-up member that pushes the sheet 90 upward from below, and a pressure detection sensor that detects the pressing force of the push-up member. Here, the lower side is the left side, and the upper side is the right side. In the following description, the same applies to the description of the function of the stiffness sensor in this paragraph. The conveyance roller also serves as the holding member. The contact surface of the push-up member with the sheet 90 is parallel to the axial direction of the conveyance rollers. The stiffness sensor holds a portion slightly inside the end portion (edge) of the sheet 90 with the conveyance rollers and lifts up the leading end of the sheet 90 that is a free end with the push-up member, thereby measuring the stiffness of the sheet 90 based on the pressing force during lifting. The vertical movement of the push-up member is controlled by a drive motor, for example, a stepping motor. In the stiffness sensor 355 that uses the conveyance roller as the holding member, the holding region (roller nip) and the contact surface of the push-up member are both in a direction orthogonal to the conveyance direction of the sheet 90 and the sheet surface (conveyance surface) of the sheet 90. The stiffness sensor 355 detects the stiffness in the sheet conveyance direction.

### Surface Property Sensor 356

The surface property sensor 356 that includes a housing, a light emitter, a collimating lens, and a plurality of light receivers (optical sensors) optically detects specular reflection light and diffuse reflection light from the surface (irradiated surface) of the sheet, as described below. Thus, the characteristics of a coating layer of the sheet 90 are detected. One of guide plates in a sheet passing region in the conveyance path is provided with an opening (measurement region) and the opening serves as an irradiation area for the light receiver. The sheet 90 inserted into and conveyed to the opening is pressed by a pressing mechanism that descends from above in the sheet passing region. Accordingly, the sheet 90 around the opening (of the guide plate) is pressed by the lower guide plate and the pressing mechanism from above. With this state, the irradiation light that has been substantially collimated by the collimating lens is emitted from the light emitter at an incident angle of 75 degrees with respect to the reference surface. The wavelength of the irradiation light is, for example, 465 nm. The plurality of light receivers receives specular reflection light and diffuse reflection light. The plurality of light receivers is arranged, for example, at three positions of reflection angles of 30 degrees (for diffuse reflection light), 60 degrees (for diffuse reflection light), and 75 degrees (for specular reflection light), or at two positions of 60 degrees and 75 degrees. The surface property sensor 356 detects the surface property of the sheet 90 based on absolute values and ratios of the intensity of light beams received by the light receivers.

### Resistance Sensor 357

The resistance sensor 357 detects the sheet resistance (electrical resistance) of the conveyed sheet 90. The resistance sensor 357 includes a pair of conveyance rollers that holds the sheet 90, and a high-voltage (HV) unit. When the sheet resistance is measured, the drive motor of the conveyance rollers is stopped at a predetermined detection position on the conveyance path to temporarily stop the sheet 90. With this state, a high voltage is applied to the upper roller (also referred to as a detection roller) of the pair of conveyance rollers by the HV unit to measure a value of a current flowing through the lower roller (counter roller) grounded via the sheet 90.

### Method for Determining Control Parameter

The controller 11 determines various control parameters according to either a first example or a second example described below.

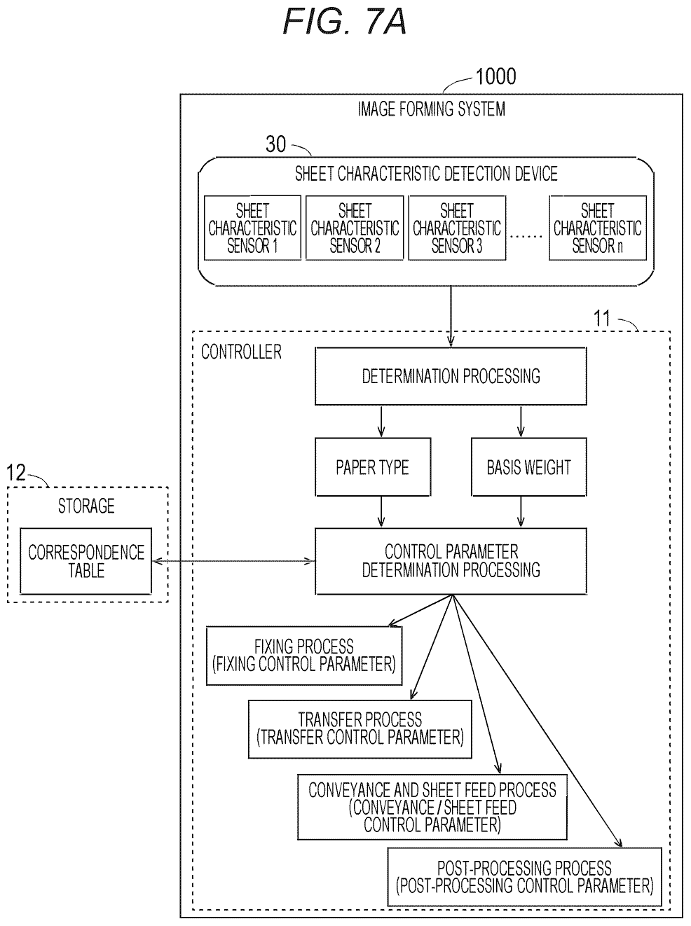

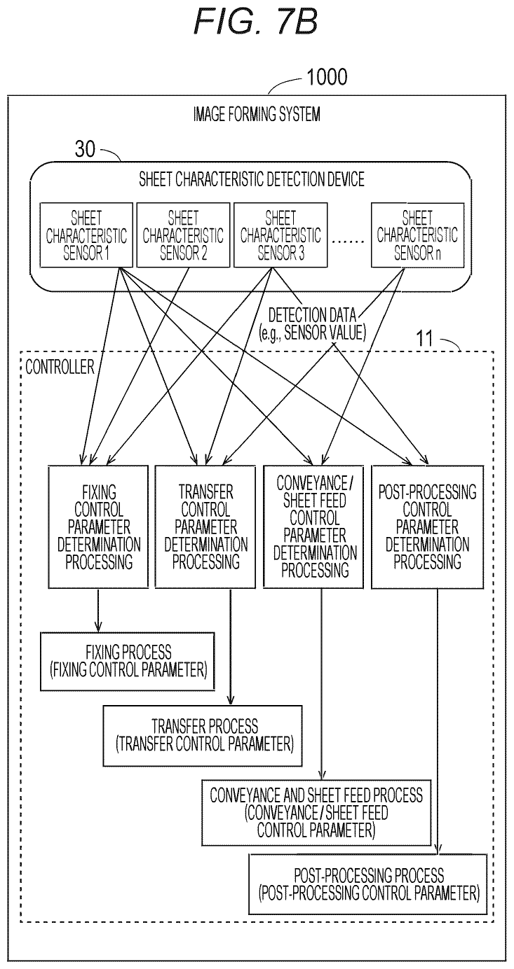

FIG. 7A is a block diagram illustrating a process of determining a control parameter from sheet characteristics in the first example. In the first example, the controller 11 determines that the sheet characteristic is either a plurality of paper types or a plurality of basis weights classified by a determination process on the basis of sheet characteristics 1 to n. The sheet characteristic sensors 1 to n correspond to any of the sensors 350 to 357 of the above-described sheet characteristic detection device 30. Then, the controller 11 performs the process of determining the control parameter based on the determined paper type and basis weight. When performing the process of determining the parameter, the controller 11 refers to a correspondence table which is stored in the storage 12 in advance and in which control values of parameters for fixing process, transfer process, conveying/feeding process, and post-processing process for each combination of paper type and basis weight are described.

The controller 11 controls the fixing process by the fixer and the transfer process by the transferer of the image former 13 using the determined fixing and transfer control parameters. Further, the controller 11 controls the sheet feed conveyor 14 using the determined conveyance/sheet feed control parameter, and the controller of the sheet feed device 20 controls the conveyance and sheet feeding process of the sheet feed device 20. Further, the controller of the post-processing device 20 controls the post-processing process using the determined post-processing control parameter.

FIG. 7B is a block diagram illustrating a process of determining a control parameter from sheet characteristics in the second example. In the first example described above, the controller 11 determines the control parameter after classifying the sheet characteristics into the paper type and the basis weight. On the other hand, in the second example, the controller 11 determines each control parameter directly from the sheet characteristics. For example, the controller 11 determines a fixing control parameter from the sheet characteristics 1, 2, and 3, and determines a transfer control parameter from the sheet characteristics 1, 3, and n. Further, the controller 11 determines a conveyance/sheet feed control parameter from the sheet characteristics 1 and n, and determines a post-processing control parameter from the sheet characteristics 1 and 3. Note that a trained model that has been trained by machine learning may be used for determining the control parameters.

### Printing Processing

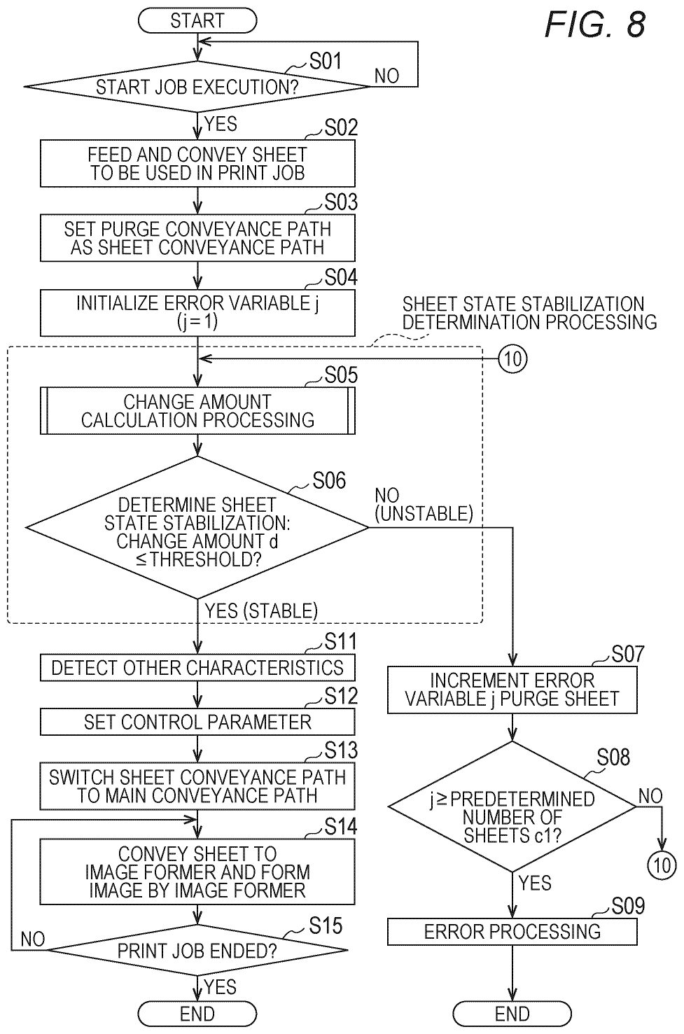

Next, printing processing executed by the image forming system 1000 will be described with reference to FIGS. 8 to 10. FIG. 8 is a flowchart illustrating printing processing according to a first embodiment. In FIG. 8, steps S01 to S12 are processes for printing preparation, and step S13 and subsequent steps are processes for executing printing.

### Steps S01 to S03

When a print job is input in response to an instruction transmitted from the terminal device 80, etc., the controller 11 feeds and conveys a sheet to be used in the print job based on print job setting information about the input print job. For example, the controller 11 causes any one of the sheet feed trays 245 of the sheet feed device 20 to feed the sheet 90, and conveys the sheet 90 through the first conveyance path 341. Further, the controller 31 controls a path switching section (not illustrated) at the branch portion j1 so that the sheet conveyance path is switched to the purge conveyance path (second conveyance path 342) leading to the purge tray 349.

### Step S04

The controller 11 initializes an error variable j (j=1).

### Step S05

Steps S05 and S06 enclosed by a broken line frame are sheet state stabilization processing.

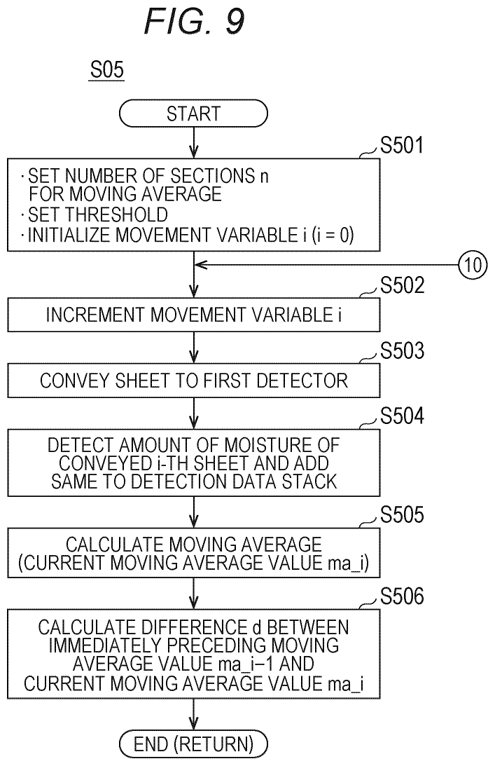

In step S05, the controllers 11 and 31 cooperate to execute change amount calculation processing. FIG. 9 is a subroutine flowchart illustrating the change amount calculation processing.

### Step S501

The controller 11 sets the number of sections n of a moving average and a threshold, and initializes a movement variable i (i=0). The number of sections n of the moving average corresponds to a first predetermined number of sheets. As described below, the controller 11 determines the sheet state stabilization based on a change in the moving average in n sections, n corresponding to the first predetermined number of sheets. The number of sections n and the threshold may be preset fixed values. The number of sections n may be set by a user through the operation panel 15, and the number of sections n is preferably 3 or more, but may be 1 or more. In a case where the number of sections n is 1 (n=1), a preceding value and a subsequent value are simply compared.

As an example of the number of sections n and the threshold, the number of sections n is 3 (n=3), and the threshold is, for example, 0.1% or 0.5%. In addition, any of the following may be adopted as a method for setting the threshold. The first example is as follows. A table in which the paper type and the threshold are associated with each other is stored in the storage 12, and the controller 11 sets the threshold using the table. Regarding the determination of the paper type, the paper type input by the user via the operation panel 15 may be used, or the paper type may be determined based on the sheet characteristic values of the first sheet detected by the first and second detectors 35a and 35b. The second example is such that the threshold is set based on detection data about the amount of moisture of the first sheet. For example, if the amount of moisture of the first sheet is 10%, the controller 11 sets, as the threshold, a value (0.5%) obtained by multiplying 10% by a predetermined coefficient (1/20).

### Step S502

The controller 11 increments i (+1).

### Steps S503 and S504

The controller 31 conveys the sheet 90 to the first detector 35a and detects the amount of moisture of the conveyed i-th sheet by the first detector 35a. The controller 11 stores the data about the amount of moisture in a detection data stack every time the detection data for each sheet is obtained. Note that as described above, the moisture percentage sensor 350 of the first detector 35a and the size sensor 351, the sheet thickness sensor 352, and the basis weight sensor 353 of the second detector 35b can detect sheet characteristic information corresponding to the size, the sheet thickness, the basis weight, and the amount of moisture (moisture percentage) while conveying the sheet 90 conveyed through the first conveyance path 341 without stopping the sheet 90. Therefore, the sensors on the first conveyance path 341 may detect another sheet characteristic other than the amount of moisture every time. In this case, the detection data about the other sheet characteristics may be deleted without being used, or may be stacked and used for setting of the control parameters by using an averaged value (steps S11 and S12 described later).

### Step S505

When the number of data i in the detection data stack is equal to or more than the number of sections n (e.g., 3), the controller 11 calculates the moving average. For example, in the case of i=10, the current moving average value ma_i of the detection data about the amount of moisture is the average value of the detection data about the amount of moisture of the eighth to tenth sheets. When the value of the variable i is less than the number of sections n, the moving average cannot be calculated, and thus the processing here is skipped. (Step S506)

The controller 11 calculates a difference d between the immediately preceding moving average value ma_i-1 and the current moving average value ma_i. For example, in the case of i=10, the controller 11 calculates a difference d between the average of the detection data about the amounts of moisture of the seventh to ninth sheets and the average of the detection data about the amounts of moisture of the eighth to tenth sheets. Then, the processing in FIG. 9 is completed, and the processing returns to the processing in FIG. 8 to execute the processes of step S06 and subsequent steps.

### Step S06

The controller 11 determines the sheet state stabilization. When the difference d calculated in step S05 is less than or equal to the threshold, it is determined that the state is stable, and the processing proceeds to step S11. On the other hand, when the difference d exceeds the threshold, the processing proceeds to step S07.

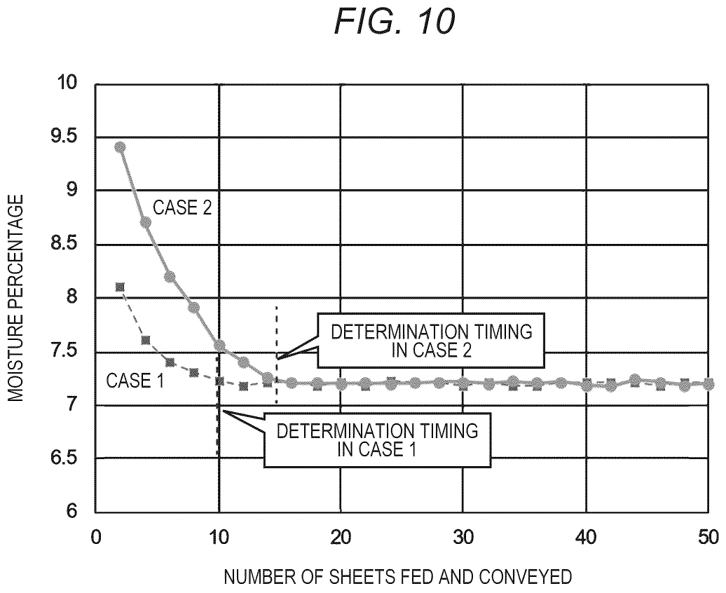

FIG. 10 is a graph illustrating transition of the amount of moisture of sheets continuously

conveyed from a sheet feed tray in two cases having different moisture conditioning states. The horizontal axis represents the number of fed sheets, and the vertical axis represents the amount of moisture (moisture percentage). In both cases 1 and 2, the sheets in a bundle of sheets left in the sheet feed tray under a high-humidity environment are fed and conveyed. The sheets in the sheet feed tray in the case 2 are left longer than the case 1, and thus, contain more moisture. In both of the cases 1 and 2, the sheets in the middle of the bundle absorb less moisture than the uppermost sheet of the bundle, and thus have less amount of moisture. Therefore, when sheets are continuously fed, the amount of moisture gradually decreases as the number of sheets increases as illustrated in FIG. 10. In FIG. 10, the determination of step S06 (YES) is performed at the determination timing of each of the case 1 and the case 2. It is found that it takes more time (the number of sheets) for stabilization in the case 2 in which the amount of moisture is high at the beginning. The sheet before the determination timing is purged, and the image formation is performed on the sheet after the determination timing by the processes of step S13 and subsequent steps to be described later.

### Step S07

The controller 11 increments the error variable j (+1). Further, the controller 31 purges the sheet 90 by controlling the conveyor 34. Due to the purge process, the sheet 90 is ejected to the purge tray 349 through the purge conveyance path (second conveyance path 342) that does not pass through the image former 13.

### Step S08

The controller 11 determines whether or not the error variable j is equal to or more than a predetermined number of sheets c1 (second predetermined number of sheets). The predetermined number of sheets c1 is a preset number of sheets. For example, the predetermined number of sheets c1 can take any value from 10 to 50. For example, the predetermined number of sheets c1 is 20. When the error variable j is equal to or larger than the predetermined number of sheets c1, the controller 11 advances the processing to step S09. On the other hand, when the error variable j is less than the predetermined number of sheets c1, the controller 11 advances the processing to step S05 (step S502) (indicated by circled number 10).

### Step S09

The controller 11 performs error processing. As the error processing, the controller 11 interrupts the sheet state stabilization determination processing and stops the operation of detecting an amount of moisture. Furthermore, the controller 11 displays, on the operation panel 15 or the like, a warning indicating that the sheet state is not stabilized within the predetermined number of sheets. The warning display may include a message prompting replacement of the sheets in the sheet feed tray. After the error processing, the processing ends (END).

### Step S11

The sheet characteristics other than the amount of moisture of the sheet 90 are detected by the second detector 35b of the sheet characteristic detection device 30. It is preferable that the sheet characteristics other than the amount of moisture are detected for the last sheet 90 for which the amount of moisture has been detected, but another sheet 90 may be newly fed, and a plurality of sheet characteristics may be detected for this sheet 90.

In addition, in a case of using the last sheet 90 for which the amount of moisture has been detected in step S11, this sheet 90 is conveyed to the second conveyance path 342 (purge conveyance path) to detect the sheet characteristics by the stiffness sensor 355, the surface property sensor 356, and the resistance sensor 357. Furthermore, the sheet characteristics using the size sensor 351, the sheet thickness sensor 352, and the basis weight sensor 353 in the conveyance path 341 can be detected without stopping the sheet. Thus, when these sheet characteristics are detected every time, the detection data about these sheet characteristics can be used.

### Step S12

The controller 11 sets control parameters of fixing, transfer, and conveyance/sheet feeding using the plurality of sheet characteristics detected in step S11. Further, the controller 11 may set the control parameter for the post-processing by using the plurality of sheet characteristics detected in step S11. The above control parameters are set with either one of the control parameter determination methods illustrated in FIGS. 7A and 7B.

### Step S13

The controller 31 controls the path switching section (not illustrated) at the branch portion j1 so that the sheet conveyance path is switched to the main conveyance path (conveyance paths 341 and 141) leading to the image former 13.

### Step S14

The controller 11 conveys the sheet 90 to the image former 13. An image is formed on the sheet 90 by the image former 13. Various control parameters for the image formation are those set in step S12.

### Step S15

When printing up to the set number of sheets of the print job has not been completed (NO), the controller 11 returns the processing to step S14, and repeats image formation on the sheet 90 until the set number of sheets is reached. When printing up to the set number of sheets is completed (YES), the controller 11 ends the processing (END).

As described above, the image forming system according to the first embodiment includes: a first detector that is disposed on the conveyance path at a position upstream of the image former in a conveyance direction of the sheet and that detects a characteristic value corresponding to an amount of moisture of the conveyed sheet; and a controller that performs a determination of whether or not the characteristic value detected by the first detector is stable and causes the image former to start image formation when determining that the characteristic value is stable. The image forming system automatically starts the image formation after confirming that the state of the sheet is stabilized as described above, whereby a burden on an operator to monitor can be reduced. Furthermore, consumption of consumable supplies such as ink and toner due to image formation in an unstable state can be reduced.

Further, in the present embodiment, sheets that are conveyed before the sheet state is determined to be stabilized are purged without forming an image, whereby wasteful use of sheets can be reduced. In particular, the image forming system purges the sheet to the purge tray by the purge conveyance path, so that the sheet can be distinguished from the sheet for the main printing and the purged sheet can be easily reused.

### Second Embodiment

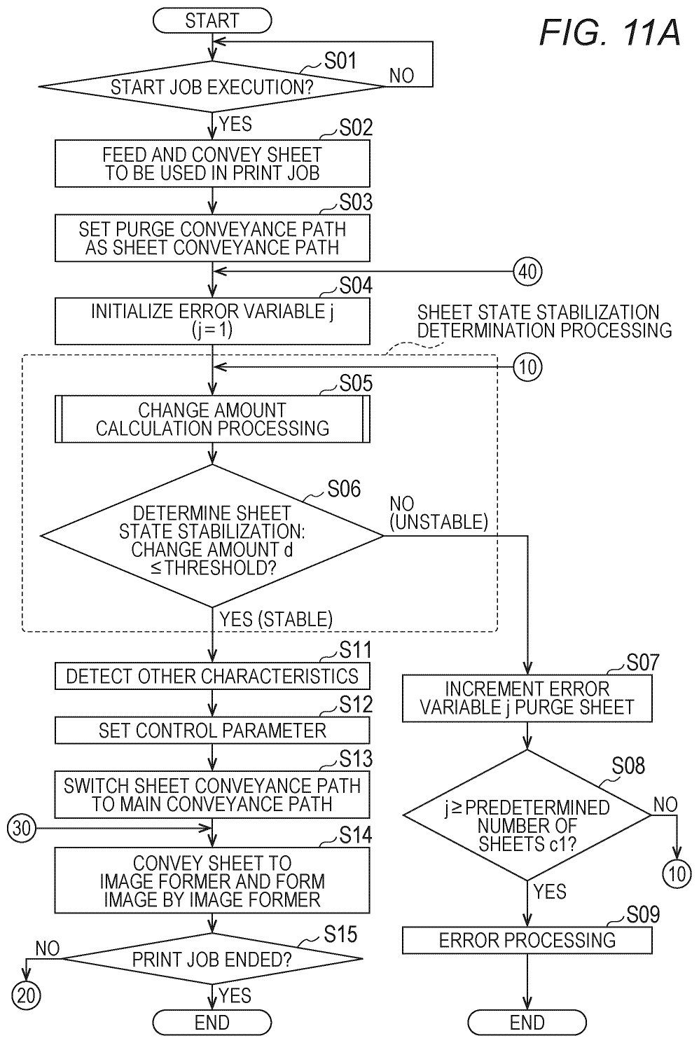

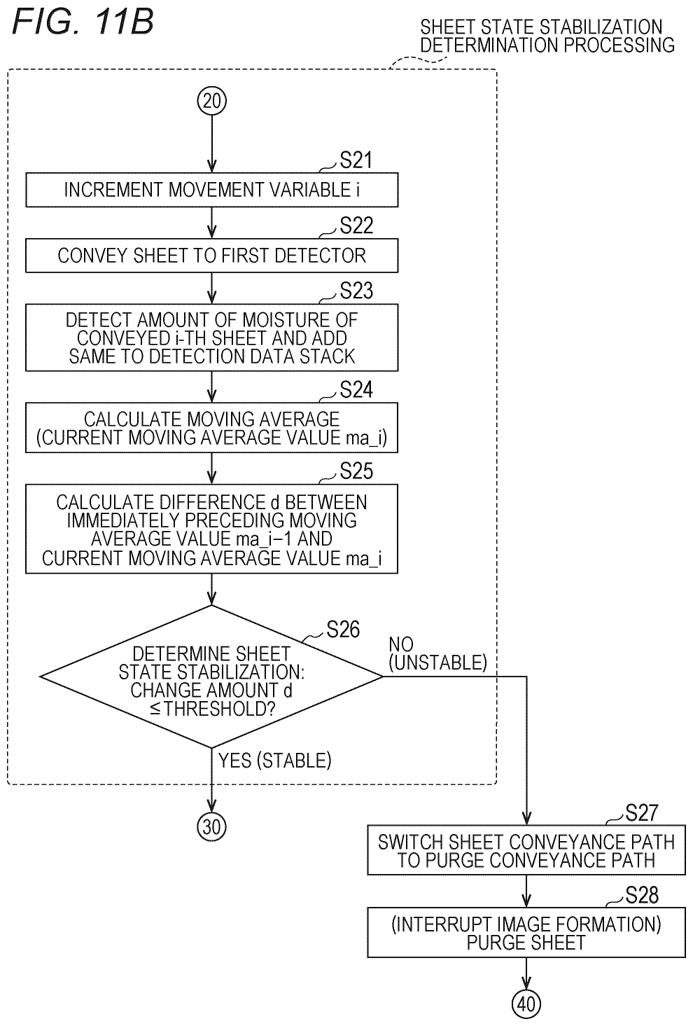

Next, an image forming system according to a second embodiment will be described with reference to FIGS. 11A and 11B. In the second embodiment, even after the state of a sheet is confirmed to be stable, the state of the sheet relating to an amount of moisture is continuously monitored, and the result of monitoring is used to interrupt or resume printing.

FIG. 11A is a flowchart illustrating printing processing in the second embodiment. FIG. 11B is a flowchart illustrating printing processing to be executed subsequent to FIG. 11A.

In FIG. 11A, the processes of steps S01 to S15 are the same as those in the flowchart in FIG. 8, and thus, the description of each process will not be repeated. In FIG. 11A, the different points from the flowchart in FIG. 8 are indicated by circled numbers 20, 30, and 40. When the print job is to be continued in step S15 (NO in step S15), the processing in FIG. 11B is performed (indicated by circled number 20).

### Steps S21 to S26

The processes of steps S21 to S25 in FIG. 11B are the same as the steps S502 to S506 in FIG. 9, and the process of step S26 in FIG. 11B is the same as the process of step S06 in FIG. 8. Note that in the processes of steps S21 to S25 in FIG. 11B, the movement variable i and the data in the detection data stack that are used in FIG. 9 are continuously used.

### Step S26

When determining that the state of the sheet regarding the sheet characteristics of the amount of moisture is stabilized by the determination of the sheet state stabilization in step S26 (YES), the controller 11 advances the processing to step S14 in FIG. 11A (indicated by circled number 30). Then, the controller 11 performs the processes of step S14 and the subsequent steps, and continues the image formation on the sheet 90.

On the other hand, when determining that the state of the sheet related to the sheet characteristic of the amount of moisture is not stable (NO), the controller 11 advances the processing to step S27.

### Step S27 and S28

The controller 31 switches the sheet conveyance path to the purge conveyance path (second conveyance path 342) and purges the sheet. Then, if image formation is in progress, the controller 11 interrupts the image formation. For example, there is a case where sheets having different moisture conditioning states are mixed in the same sheet feed tray. Examples of such a case include a case where a new bundle of sheets is added to (stacked on) a bundle of sheets that has been left in a sheet feed tray under a high-humidity environment for a long time. In this case, after the sheets of the newly added bundle of sheets are used up by printing, the sheets that have been left under a high-humidity environment to have an increased amount of moisture are conveyed, and thus, it is determined that the sheet state is not stable.

Thereafter, the controller 11 advances the processing to step S04 in FIG. 11A (indicated

by circled number 40), and executes the sheet state stabilization determination processing in step S05 and subsequent steps. When determining that the state of the sheet is stabilized, the controller 11 resumes the image formation in the print job that has been interrupted.

As described above, the image forming system according to the second embodiment performs the same processing as that in the first embodiment. Further, the image forming system continues to detect the characteristic value of the sheet by the first detector after the image formation by the image former is started, and when determining that the characteristic value detected by the first detector is not stabilized during the image formation, interrupts the image formation by the image former. Further, even after interrupting the image formation, the controller continuously executes the detection by the first detector, and when determining that the detected characteristic value is then stabilized, the controller resumes the image formation by the image former.

As a result, the same effect as that of the first embodiment can be obtained, and furthermore, in the second embodiment, it is possible to suppress a change in print quality due to the instability of the state of sheet in the middle of the print job.

The configurations of the sheet characteristic detection device 30 and the image forming system 1000 including the sheet characteristic detection device 30 described above are merely main configurations for describing the features of the embodiments described above, are not limited to the configurations described above, and can be modified in various manners within the scope of the claims. Furthermore, the descriptions above are not intended to exclude any configuration included in a general image forming apparatus.

The above-described embodiments have described an example in which the second detector 35b includes six sensors which are the size sensor, the sheet thickness sensor, the basis weight sensor, the stiffness sensor, the surface property sensor, and the resistance sensor. However, the invention is not limited thereto, and the second detector 35b may include at least one or more sensors instead of all of the six sensors.

Further, the terminal device 80 illustrated in FIG. 1 may be included in the configuration of the image forming system. Then, the terminal device 80 may have a part of the functions of the controller 11 and/or the controller 31. For example, the processing illustrated in FIG. 8 and the like is also performed on the terminal device 80 side in cooperation.

Furthermore, means and methods of performing various kinds of processing in the sheet characteristic detection device 30 and the image forming system 1000 according to the above embodiments can be implemented by any of a dedicated hardware circuit or a programmed computer. The program may be provided by, for example, a computer-readable recording medium such as a USB memory or a digital versatile disc (DVD)-ROM, or may be provided online via a network such as the Internet. In this case, the program recorded on the computer-readable recording medium is commonly transferred to and stored in a storage such as a hard disk. In addition, the program may be provided as independent application software or may be incorporated into software of an apparatus as one function of the apparatus.

While the embodiments of the present invention have been described and illustrated in detail, the disclosed embodiments have been created for purposes of illustration and example only, and not limitation. The scope of the present invention is to be interpreted by the wording of the appended claims.

What is claimed is:

1. An image forming system comprising:
an image former that forms an image on a sheet conveyed through a conveyance path;
a first detector that is disposed on the conveyance path at a position upstream of the image former in a conveyance direction of the sheet and that detects a characteristic value corresponding to an amount of moisture of the conveyed sheet; and
a controller that performs a determination of whether or not the characteristic value detected by the first detector is stable and causes the image former to start image formation when determining that the characteristic value is stable.

2. The image forming system according to claim 1, further comprising
a sheet feed tray that stores a plurality of sheets, wherein
the first detector detects a sheet continuously fed and conveyed from the sheet feed tray, and
the controller performs the determination based on a change in the characteristic values of the plurality of sheets.

3. The image forming system according to claim 2, wherein the controller performs the determination based on a change in a moving average of the characteristic values for a first predetermined number of sheets continuously conveyed.

4. The image forming system according to claim 2, wherein the controller executes purging processing for ejecting a sheet that has been detected by the first detector onto an ejector without performing image formation until determining that the characteristic value is stabilized.

5. The image forming system according to claim 4, further comprising
a purge conveyance path branching from the conveyance path on an upstream side of the image former and on a downstream side of the first detector on the conveyance path, wherein
the purge processing includes ejecting the sheet through the purge conveyance path.

6. The image forming system according to claim 2, wherein the controller interrupts a detection operation by the first detector when not determining that the characteristic value is stabilized even after a second predetermined number of sheets are conveyed.

7. The image forming system according to claim 6, wherein the controller notifies a user that a characteristic of the sheet in the sheet feed tray is not stabilized, in addition to interrupting the detection operation.

8. The image forming system according to claim 1, wherein the controller sets a control parameter for the image former on the basis of the characteristic value determined to be stable.

9. The image forming system according to claim 8, further comprising
a second detector that detects one or more types of characteristic values of the sheet other than the amount of moisture,
the image forming system setting the control parameter for the image former based on a plurality of characteristic values obtained by detecting the sheet that has been determined to be stable by the first detector and the second detector.

10. The image forming system according to claim 8, wherein the control parameter includes a control parameter related to at least one of transfer, fixing, and conveyance.

11. The image forming system according to claim 1, wherein
the first detector continues to detect the characteristic value of the sheet after the image formation by the image former is started, and
the controller interrupts the image formation by the image former when determining that the characteristic value detected by the first detector is not stable during the image formation.

12. The image forming system according to claim 11, wherein
the controller continuously executes a detection of the characteristic value of the sheet by the first detector after the image formation is interrupted, and
the controller resumes the image formation by the image former when determining that the characteristic value detected by the first detector is stabilized.

13. A non-transitory computer-readable recording medium storing a control program for causing a computer to execute:
a step (a) of detecting a characteristic value of a sheet by a first detector that is disposed on a conveyance path at a position upstream of an image former in a conveyance direction of the sheet and that detects a characteristic value corresponding to an amount of moisture of the conveyed sheet; and
a step (b) of determining whether or not the characteristic value detected in the step (a) is stable and causing the image former to start image formation when determining that the characteristic value is stable.
